(19) United States
(12) Patent Application Publication
(10) Pub. No.: US 2007/0147061 A1
(43) Pub. Date: Jun. 28, 2007

(54) Light beam adjusting device for vehicle

(75) Inventors: Jihn Shiun Lee, Tainan (TW); Chih Ming Tsai, Taichung (TW); Jen Mao Wang, Changhua (TW)

Correspondence Address: CHARLES E. BAXLEY, ESQ., 90 JOHN STREET, THIRD FLOOR, NEW YORK, NY, 10038, US

(73) Assignees: China Technology Co., Ltd.; Fu An Industrial Co., Ltd.

(21) Appl. No.: 11/636,213

(22) Filed: Dec. 7, 2006

(30) Foreign Application Priority Data
Dec. 27, 2005 (TW) 094222703

(51) Int. Cl. F21V 11/18; F21V 14/08; B60Q 1/04

(52) U.S. Cl. 362/513; 362/284; 362/324

(57) ABSTRACT

A light beam adjusting device includes a housing having a reflector, a light device disposed within the reflector for generating light which may be reflected partially upwardly and partially downwardly by the reflector. The light reflected downwardly by the reflector is allowed to emit out through the housing. A shielding panel is disposed in the housing, and an actuating device may rotate the shielding panel to open and block the lower portion of the housing, and to selectively open and block the light reflected upwardly by the reflector. The light reflected upwardly by the reflector may form a high beam together with the downwardly reflected light when the lower portion of the housing is not blocked by the shielding panel.

### BACKGROUND OF THE INVENTION

1. Field of the Invention

The present invention relates to a vehicle headlight adjusting device, and more particularly to a vehicle headlight having a light beam adjusting device for adjusting the headlight to different light beams or to different light intensities.

2. Description of the Prior Art

Typical vehicle headlights comprise a light beam adjusting device to adjust the headlight to different light beams or to different light intensities, such as to the high beam and to the low beam. For example, the typical vehicle light beam adjusting devices comprise a light bulb or light device slidably received in a reflector, and movable relative to the reflector, in order to adjust to different light beams.

For example, U.S. Pat. No. 6,325,528 to Wittmeier et al. discloses one of the typical vehicle headlights including a light beam adjusting device having a light bulb slidably or movably received within a reflector and coupled to a light source base which is tiltable and rotatable or actuatable relative to the reflector by an electromagnetic solenoid, in order to adjust the typical vehicle headlights to different light beams. However, some of the light portion generated by the light bulb may be reflected or emitted upwardly by the reflector in order to form the high beam inadvertently which is adverse for the drivers of the head to head vehicles.

U.S. Pat. No. 6,386,744 to Scholl discloses another typical vehicle headlight including a light source mounted in a reflector, and light ray stop having a pot-shaped region arranged to block off a part of the light from the light source so that it does not reach the reflector. However, the typical vehicle headlight may not be adjusted to different light beams.

The present invention has arisen to mitigate and/or obviate the afore-described disadvantages of the conventional vehicle light beam adjusting devices.

### SUMMARY OF THE INVENTION

The primary objective of the present invention is to provide a vehicle light beam adjusting device for adjusting the headlight to different light beams or to different light intensities, and for preventing the light portion generated by the light bulb from being reflected or emitted upwardly as a high beam by the reflector of the vehicle headlight.

In accordance with one aspect of the invention, there is provided a light beam adjusting device comprising a housing including a reflector, and including a lower portion, a light device disposed within the reflector, for generating light, and for allowing the light to be reflected upwardly and reflected downwardly by the reflector, the light reflected downwardly by the reflector being allowed to emit out through the housing, a shielding panel pivotally supported in the housing, and a rotating device for rotating the shielding panel to selectively open and block the lower portion of the housing and to selectively open and block the light reflected upwardly by the reflector and thus to allow the lights to be easily and quickly changed or adjusted between the high beams and the low beams, the light reflected upwardly by the reflector may form a high beam together with the light reflected downwardly by the reflector when the lower portion of the housing is opened and is not blocked.

The rotating device includes a solenoid device to selective rotate the shielding panel to selectively open and block the passage of the frame.

A frame may further be provided and attached to the lower portion of the housing, and the frame includes a passage formed therein for allowing the light reflected upwardly by the reflector to emit out through the passage of the frame, the shielding panel is pivotally attached to the frame, to selectively block the passage of the frame.

The frame includes at least one ear extended therefrom, the shielding panel includes at least one arm extended therefrom and pivotally attached to the ear of the frame with a pivot axle for allowing the shielding panel to be pivoted relative to the frame with the pivot axle.

The rotating device includes an actuator coupled to the arm of the shielding panel to selective pivot the shielding panel to selectively open and block the passage of the frame. The solenoid device includes a core slidably received in a coil and coupled to the actuator to selectively move the actuator to rotate the shielding panel relative to the frame.

The core includes a narrowed neck portion formed therein, the actuator includes a channel formed therein and defined between two fingers to slidably engage with the neck portion of the core. The pivot axle includes a U-shaped intermediate anchoring segment formed therein.

A reinforcing plate may further be provided and attached and secured to the frame for reinforcing the frame. A partition may further be provided and attached to a front portion of the housing. A casing may further be provided and attached to the partition. The casing includes a lens disposed therein.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a partial exploded view of a vehicle light beam adjusting device in accordance with the present invention;

FIG. 2 is a partial cross sectional view of the vehicle light beam adjusting device;

FIG. 3 is a partial cross sectional view similar to FIG. 2, illustrating the operation of the vehicle light beam adjusting device;

FIG. 4 is a partial exploded view illustrating the elements of the vehicle light beam adjusting device; and

FIG. 5 is a partial perspective view of the vehicle light beam adjusting device.

### DETAILED DESCRIPTION OF THE PREFERRED EMBODIMENT

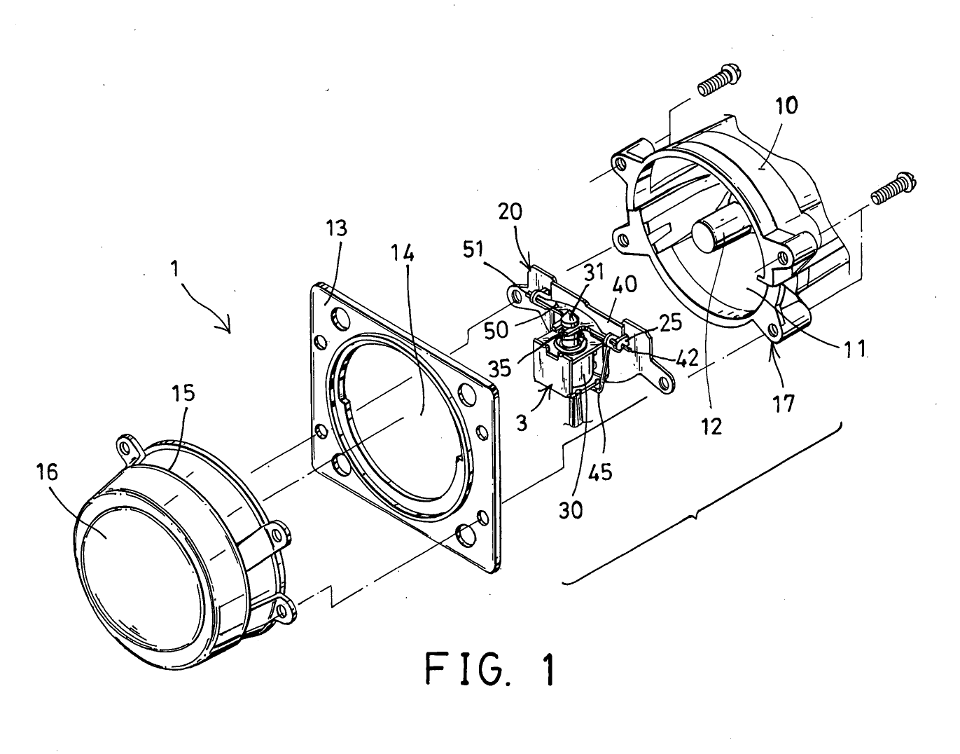

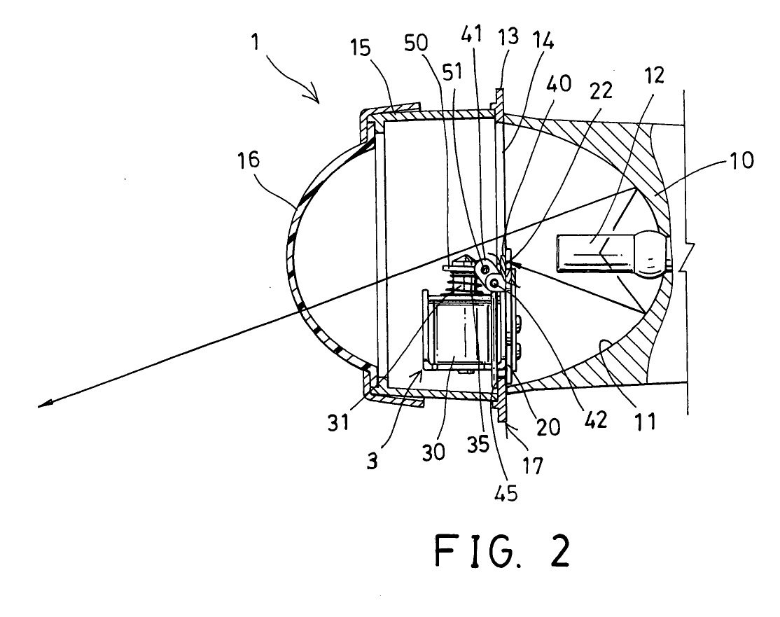

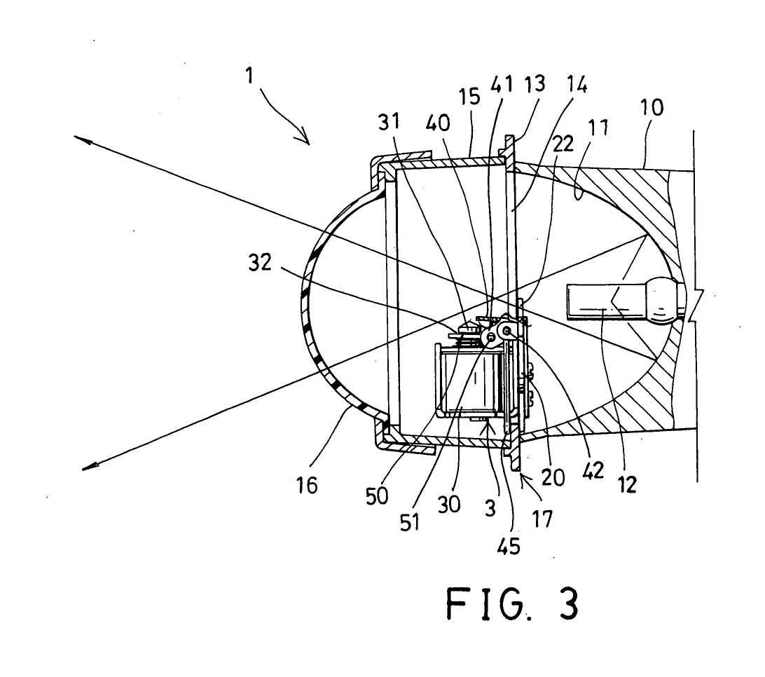

Referring to the drawings, and initially to FIGS. 1-3, a vehicle headlight 1 in accordance with the present invention comprises a housing 10 including a reflector 11 disposed or provided therein, a light bulb or light device 12 disposed within the reflector 11, for generating light beams, and arranged for allowing the light beams to be reflected by the reflector 11 (FIGS. 2, 3). A partition 13 may be attached to a front portion of the housing 10 with such as latches or fasteners (not shown), and includes an opening 14 formed therein. A casing 15 may further be provided and secured to a front portion of the partition 13 or directly attached to the front portion of the housing 10 with such as the latches or fasteners (not shown), and a lens 16, such as a convex lens, or transparent lens 16 is attached to the front portion of the casing 15.

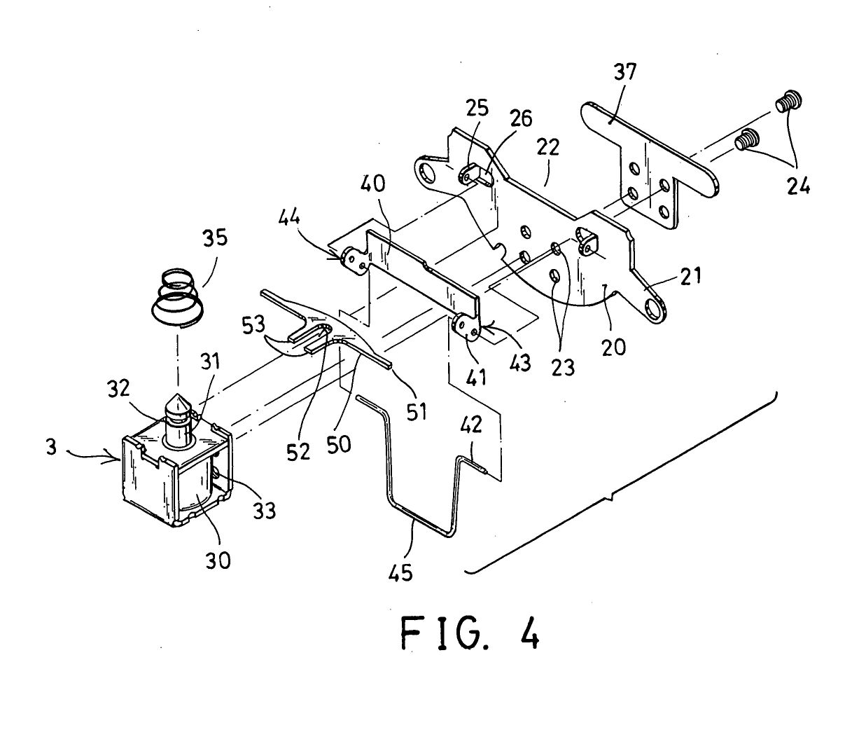

A frame 20 includes two side extensions 21 attached or secured to a lower portion 17 of the housing 10 or of the partition 13 with such as latches or fasteners (not shown), and includes a passage 22 formed therein, such as formed in the upper portion of the frame 20 and aligned with or located within the lower portion 17 of the housing 10, for allowing the light generated by the light device 12 to be selectively emitted out through the passage 22 of the frame 20 (FIG. 3). The frame 20 includes one or more apertures 23 formed therein for receiving fasteners 24 (FIG. 4) which may be used to secure an actuating device or a solenoid device 3 to the frame 20, and includes one or more (such as two) ears 25 extended therefrom and each may be punched or formed from the frame 20 for defining an opening 26 in the frame 20.

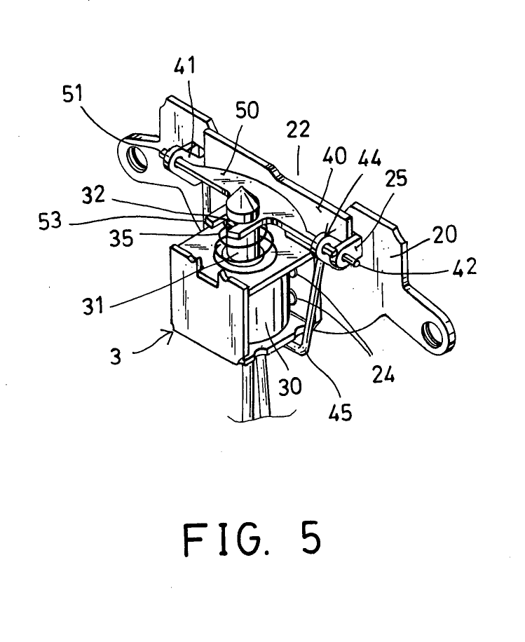

The solenoid device 3 includes a coil 30, a core 31 slidably received in the coil 30 and movable or actuatable by the coil 30. It is preferable that the core 31 includes a narrowed neck portion 32 formed therein. The solenoid device 3 includes one or more holes 33 formed therein (FIG. 4), for receiving the fasteners 24 (FIG. 5) which may secure the solenoid device 3 to the frame 20. A spring member 35 may further be provided, and such as engaged onto the core 31, for biasing or recovering the core 31 relative to the coil 30 of the solenoid device 3. A reinforcing plate 37 (FIG. 4) may be made of stronger materials and may be attached to the rear portion of the frame 20 and secured to the frame 20 with the fasteners 24 for reinforcing the frame 20.

A shielding panel 40 includes one or more (such as two) arms 41 extended therefrom and pivotally or rotatably attached or secured to the frame 20, such as to the ears 25 of the frame 20 with such as a pivot axle 42 for allowing the shielding panel 40 to be pivoted or rotated relative to the frame 20 with the pivot axle 42 (FIGS. 2, 3). The shielding panel 40 may also be directly and pivotally or rotatably attached or secured to or supported in the lower portion 17 of the housing 10 without the frame 20. It is preferable that the arms 41 are inclined or tilted relative to the shielding panel 40, and the pivot axle 42 is located close to the shielding panel 40 and the frame 20 or attached to the root portion 43 of the arms 41, but distal to a free end portion 44 of the arms 41 (FIG. 4). The pivot axle 42 may be directly formed from a longitudinal wire or cable which is bent or folded to form a U-shaped intermediate anchoring segment 45 in the middle portion of the pivot axle 42.

For example, the anchoring segment 45 of the pivot axle 42 may be engaged with the solenoid device 3 (FIG. 5) and/or the partition 13 or the housing 10 (FIGS. 2, 3) for anchoring or positioning the pivot axle 42 to the partition 13 or the housing 10 or the solenoid device 3. The pivotally or rotatably attaching or coupling of the shielding panel 40 to the frame 20 allows the shielding panel 40 to be rotated relative to the frame 20 between an upwardly working position to selectively shield or block the passage 22 of the frame 20 (FIGS. 1, 2, 5) and a downwardly or horizontally folding or receiving position to selectively open the passage 22 of the frame 20 (FIG. 3) and thus to allow the light generated by the light device 12 to selectively emit out through the passage 22 of the frame 20.

A follower or actuator 50 includes two ends 51 engaged through or coupled to the arms 41 of the shielding panel 40 and preferably located closer to the free end portion 44 of the arms 41 but distal to the root portion 43 of the arms 41, or spaced away from the pivot axle 42 for allowing the shielding panel 40 to be rotated relative to the frame 20 between the upwardly working position to selectively shield or block the passage 22 of the frame 20 (FIGS. 1, 2, 5) and the downwardly or horizontally folding or receiving position to selectively open the passage 22 of the frame 20 (FIG. 3) by the actuator 50 when the actuator 50 is moved up and down relative to the shielding panel 40 and the frame 20 and the solenoid device 3 by the core 31 of the solenoid device 3.

For example, the actuator 50 includes an oblong hole or channel 52 formed therein and defined between two fingers 53 to slidably receive or engage with the neck portion 32 of the solenoid device 3; i.e., the fingers 53 may be engaged into the narrowed neck portion 32 of the core 31 of the solenoid device 3 to allow the actuator 50 to be engaged with or coupled to the core 31 of the solenoid device 3, and thus to allow the actuator 50 to be moved up and down relative to the shielding panel 40 and the frame 20 and the solenoid device 3 by the core 31 of the solenoid device 3, and thus to cause the shielding panel 40 to selectively shield or block the passage 22 or to selectively open the passage 22 of the frame 20 (FIG. 3). The sliding engagement of the channel 52 or the fingers 53 of the actuator 50 with the neck portion 32 of the solenoid device 3 allows the fingers 53 of the actuator 50 to be slightly slid relative to the core 31 of the solenoid device 3.

As shown in FIGS. 2 and 3, the light generated by the light device 12 may be selectively emitted out through the opening 14 of the partition 13. The upper portion of the opening 14 of the partition 13 has not been blocked or shielded such that the light reflected downwardly by the reflector 11 will not be blocked or shielded, and may emit freely out of the casing 15 and the lens 16 to form a low beam. The other portion of the light generated by the light device 12 and reflected upwardly by the reflector 11 may be selectively emitted out through the passage 22 of the frame 20 (FIG. 3), but may be selectively blocked or shielded by the shielding panel 40 (FIG. 2) when the shielding panel 40 is rotated upwardly relative to the frame 20 to block the passage 22 of the frame 20.

In operation, as shown in FIG. 2, when the actuating device or the solenoid device 3 has not be actuated or energized or operated, the spring members 35 may bias or move or rotate the actuator 50 upwardly relative to the frame 20 to block the passage 22 of the frame 20, and thus to block and to prevent the other portion of the light generated by the light device 12 and reflected upwardly by the reflector 11 from being emitted or transmitted out through the passage 22 of the frame 20. At this moment, only a portion of the light generated by the light device 12 may be reflected and emitted downwardly by the reflector 11, and may be emitted or transmitted out through the opening 14 of the partition 13 to form the low beam. The light generated by the light device 12 and reflected upwardly by the reflector 11 will not be emitted or transmitted out through the opening 14 of the partition 13 at this moment.

On the contrary, as shown in FIG. 3, the shielding panel 40 may be rotated relative to the frame 20 by the actuator 50 or the core 31 of the solenoid device 3 to selectively open the passage 22 of the frame 20, and thus to allow the other portion of the light generated by the light device 12 and reflected upwardly by the reflector 11 to be selectively emitted out through the passage 22 of the frame 20. At this moment, and simultaneously, the light generated by the light device 12 and reflected downwardly by the reflector 11 may also be emitted or transmitted out through the opening 14 of the partition 13 to form the high beam or to form a high intensity light beam together with the light reflected and emitted upwardly by the reflector 11.

The spring biasing devices or spring members 35 and the actuating device 3 may thus be formed as an actuating means or device for selectively causing or moving or rotating the shielding panel 40 to open or block the lower portion 17 of the housing 10, and thus for allowing the light reflected upwardly by the reflector 11 to be selectively blocked by the shielding panel 40 and by the actuating means or device formed or defined by the spring biasing devices or spring members 35 and the actuating device 3. It is to be noted that the shielding panel 40 may be directly and pivotally attached to the lower portion 17 of the housing 10, without the frame 20, to selectively open or block the lower portion 17 of the housing 10, and thus to allow the light generated by the light device 12 and reflected upwardly by the reflector 11 to be selectively opened or blocked by the shielding panel 40.

Accordingly, the vehicle headlight in accordance with the present invention includes a light beam adjusting device for adjusting the headlight to different light beams or to different light intensities, and for preventing the light portion generated by the light bulb from being reflected or emitted upwardly by the reflector of the vehicle headlight.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A light beam adjusting device comprising:
a housing including a reflector, and including a lower portion,
a light device disposed within said reflector, for generating light, and for allowing the light to be reflected upwardly and reflected downwardly by said reflector, the light reflected downwardly by said reflector being allowed to emit out through said housing,
a frame attached to said lower portion of said housing, and including a passage formed therein for allowing the light reflected upwardly by said reflector to emit out through said passage of said frame,
a shielding panel pivotally supported in said frame with a pivot axle to selectively block said passage of said frame, said shielding panel including at least one arm extended therefrom,
an actuator coupled to said at least one arm of said shielding panel to pivot said shielding panel to selectively open and block said passage of said frame, and
a solenoid device coupled to said actuator to actuate said actuator to rotate said shielding panel to selectively open and block said passage of said frame and to selectively open and block the light reflected upwardly by said reflector,
the light reflected upwardly by said reflector forming a high beam together with the light reflected downwardly by said reflector when said lower portion of said housing is opened and is not blocked.

2. The vehicle light beam adjusting device as claimed in claim 1, wherein said solenoid device includes a core slidably received in a coil and coupled to said actuator to selectively move said actuator to rotate said shielding panel relative to said frame.

3. The vehicle light beam adjusting device as claimed in claim 2, wherein said core includes a narrowed neck portion formed therein, said actuator includes a channel formed therein and defined between two fingers to slidably engage with said neck portion of said core.

4. The vehicle light beam adjusting device as claimed in claim 1, wherein said frame includes at least one ear extended therefrom and pivotally attached to said at least one arm of said shielding panel with said pivot axle for allowing said shielding panel to be pivoted relative to said frame.

5. The vehicle light beam adjusting device as claimed in claim 4, wherein said pivot axle includes a U-shaped intermediate anchoring segment formed therein.

6. The vehicle light beam adjusting device as claimed in claim 1 further comprising a reinforcing plate attached and secured to said frame for reinforcing said frame.

7. The vehicle light beam adjusting device as claimed in claim 1 further comprising a partition attached to a front portion of said housing.

8. The vehicle light beam adjusting device as claimed in claim 7 further comprising a casing attached to said partition.

9. The vehicle light beam adjusting device as claimed in claim 7, wherein said casing includes a lens disposed therein.
